(19) United States
(12) Patent Application Publication
(10) Pub. No.: US 2007/0090688 A1
(43) Pub. Date: Apr. 26, 2007

(54) Control system for a vehicle combination

(75) Inventors: Carsten Haemmerling, Ehningen (DE); Harro Heilmann, Ostfildern (DE); Frank Renner, Filderstadt (DE); Andreas Schwarzhaupt, Landau (DE); Genot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/547,466

(22) PCT Filed: Feb. 22, 2005
(86) PCT No.: PCT/EP05/01808

§ 371 Date: Jan. 5, 2007

(30) Foreign Application Priority Data
Feb. 27, 2004 (DE) 10 2004 009 465.9

(51) Int. Cl. B60T 13/00

(52) U.S. Cl. 303/7

(57) ABSTRACT

A control system for a vehicle combination comprises a towing vehicle and a trailer, with an electronically activatable drive train. A manual operator control device, which is fixed on the towing vehicle, can be used by the vehicle driver to input a driving request for manual operation of the vehicle combination, from which request a standardized movement vector is generated. A control device (19), which is fixed on the towing vehicle, outputs control signals for activating the drive train based on an input movement vector. For the transmission of the control signals, the control device is coupled to the drive train, which processes the control signals to implement the driving request. To improve the functionality of the control system, a trailer coordination device, which is mounted on the towing vehicle, can be used to read in at least one trailer-specific actual value and pass on the actual value to the control device. The control device generates the control signals based on the at least one trailer-specific actual value.

This application claims the priority of German patent document 10 2004 009 456.9, filed Feb. 27, 2004 (PCT International Application No. PCT/EP2005/001808, filed Feb. 22, 2005), the disclosure of which is expressly incorporated by reference herein.

The invention relates to a control system for a vehicle combination comprising a towing vehicle and a trailer, with an electronically activatable drive train that includes a steering system, a braking system and a drive unit.

German patent document DE 100 32 179 A1 discloses such a vehicle control system in which an operator control device fixedly installed in the vehicle defines an input level that can be used by a vehicle driver to input a driving request, and generates a standardized movement vector from the driving request. Using the movement vector, a control device, which defines a coordination level, generates output control signals for activating the drive train from the movement vector. For the transmission of the control signals, the control device is in this case coupled to the drive train, which then processes such signals to implement the driving request. The known control system exhibits a high degree of flexibility, since differently configured input levels and differently configured coordination levels can be combined with one another in a particularly simple manner, provided that the implementation of the driving request by conversion into the control signals always takes place via the standardized movement vectors.

In commercial vehicles (such as trucks for example), a person directing operations (ground guide) is required for maneuvering, especially reversing, in order to reduce the risk of collision between the vehicle and an obstacle. In addition, maneuvering (particularly reversing), is especially difficult in the case of a multi-element vehicle (vehicle combination) comprising a towing vehicle and a trailer, due to the kinematic coupling that exists between the towing vehicle and the trailer. Here too, a ground guide may be useful to make maneuvering easier for the vehicle driver.

However, the requirement for a ground guide is extremely onerous from an economic viewpoint, at least in the case of a truck, which performs mainly a transporting function in which no ground guide is required, and which has to be maneuvered for only an extremely short period of its operating time. It is therefore advantageous to dispense with the need for a ground guide.

One object of the present invention is to provide an improved control system of the type described above, which in particular simplifies the maneuvering of the vehicle combination equipped with the control system.

This and other objects and advantages are achieved by the control system according to the invention, in which trailer-specific parameters or actual values can be read into the control system with the aid of a trailer coordination device. The control device is also designed to generate the control signals from the supplied movement vectors, dependent on these trailer-specific parameters or actual values. By taking account of the trailer-specific actual values in the determination of the control signals, the difficulties or risks occurring during the maneuvering (especially reversing) of a vehicle combination can be automatically reduced.

A trailer-specific actual value which can be taken into account in the determination of the control signals is, for example, an articulating angle which occurs between the towing vehicle and the steering towbar, in a trailer that is steered by means of a steering towbar, between the towing vehicle and the semitrailer in a semitrailer, or, between the towing vehicle and the rigid towbar in a trailer fixedly connected to a rigid towbar. A further example of a trailer-specific actual value is a towbar angle which occurs between the trailer and the steering towbar in the case of a trailer steered by a steering towbar. By takingaccount of the articulating angle and/or the towbar angle, the achievable vehicle speed can be limited, for example to avoid unstable states. Similarly, wedging of the vehicle combination can be avoided by taking account of at least one such during reversing.

In one embodiment of the invention, the trailer coordination device may either be integrated in the form of hardware or implemented by software, in the control device. The added cost to achieve the control system according to the invention is therefore relatively low, at least in the case of commercial vehicles. On the other hand, it is also possible to design the trailer coordination deviceseparately, in a control unit on its own, so that it is possible to retrofit or convert vehicles which have an activatable drive train with a control device, at a relatively low cost. The trailer-specific actual values can be taken into account in the determination of the control signals, by corresponding reprogramming of the control device.

In a particularly advantageous embodiment of the invention, it is possible to provide for the control system at least one autonomous operator control device, which is independent of the vehicle combination, can be used to input a driving request for autonomous operation of the vehicle combination and generates a standardized movement vector from the driving request. In this way, the vehicle combination can be operated manually (that is, by a vehicle driver sitting in the cockpit of the towing vehicle) and autonomously (independently of the actual vehicle driver). An autonomous operator control device of this type may be designed for example as a remote control, which makes it possible for an operator to operate the vehicle combination from a distance. This also has the effect in particular that maneuvering of the vehicle is simplified. An autonomous operator control device of this type can be used for example at an automated inspection yard or operations yard or logistics center for vehicles which can be driven autonomously.

According to another embodiment of the invention, a steering system of the vehicle may have a steering column for mechanical and/or hydraulic coupling of a manual steering device (for example a steering wheel or joystick) to steerable wheels of the vehicle. The steering system also has an electronically activatable steering actuator, which is drive-connected to the steering column, and can be activated by the control signals of the steering device, at least during the autonomous operation of the vehicle combination. With the aid of the steering actuator, a conventional towing vehicle can be converted or retrofitted with a mechanical and/or hydraulic steering column in a particularly simple manner, in order to realize the control system according to the invention. With these features, conventional vehicles that can be operated only manually can be converted simply and inexpensively into vehicles which can be operated autonomously, so that they can be used in an automated freight forwarding yard or operations yard or logistics center.

It goes without saying that the features mentioned above and those still to be explained below can be used not only in the respectively specified combination, but also in other combinations or on their own without departing from the scope of the present invention.

Other objects, advantages and novel features of the present invention will become apparent from the following detailed description of the invention when considered in conjunction with the accompanying drawings.

### BRIEF DESCRIPTION OF THE DRAWINGS

FIGS. 1 to 3 are simplified schematically diagrams of various embodiments of a control system according to the invention;

FIGS. 4a to 4c are schematic plan views, similar to pictograms, of various vehicle combinations, comprising a towing vehicle and a trailer, which can be equipped with the control system according to the invention.

### DETAILED DESCRIPTION OF THE DRAWINGS

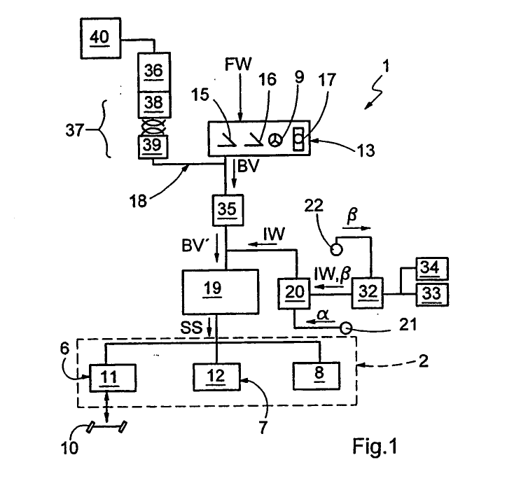

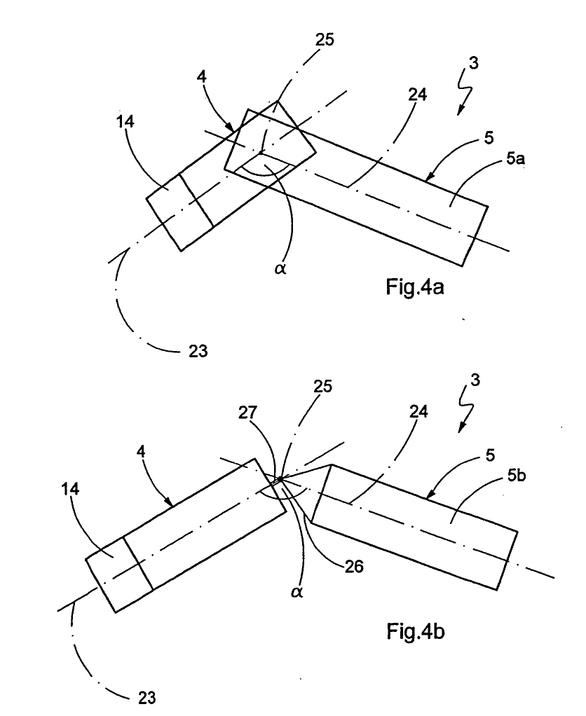

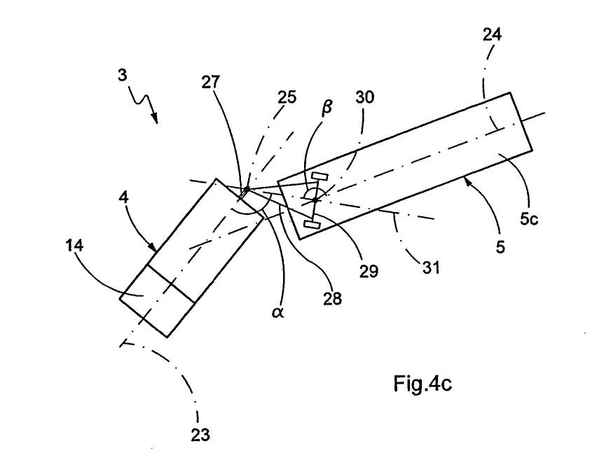

According to FIG. 1, a control system 1 according to the invention comprises a drive train 2 of a vehicle shown in FIGS. 4a to 4c, which is designed as a vehicle combination 3 and accordingly has a towing vehicle 4 and a trailer 5. The drive train 2 is designed so that it can be electronically activated, and the control system 1 can also be referred to, therefore, as a drive-by-wire system or an x-by-wire system.

The drive train 2 of the vehicle combination 3 comprises a steering system 6, a braking system 7 and a drive unit 8. Furthermore, the drive train 2 may have an electronically activatable transmission and a level control device as well as further components.

In the embodiment represented in FIG. 1, the steering system 6 is formed as a steer-by-wire system and, at least in normal operation, operates without mechanical and/or hydraulic coupling between a manual steering means 9 (a steering wheel) and steerable vehicle wheels 10. For this purpose, the steering system 6 comprises a steering actuator 11, which, in a way similar to a servomotor, sets the desired steering angle at these steerable wheels 10.

The braking system 7 comprises one or more braking actuators 12, which are actuatable to introduce a desired braking forces at brakable vehicle wheels. The drive unit 8 may be an electric motor or an electrically activatable internal combustion engine.

The control system 1 also comprises a manual operator control device 13, which is fixedly arranged on the towing vehicle 4 (FIGS. 4a, 4b). While the drive train 2 forms an output level, the manual operator control device 13 defines an input level of the control system 1. The manual operator control device 13 is arranged in a cockpit 14 of the towing vehicle 4 (compare FIG. 4) and comprises a number of operating elements which can be manually actuated by the vehicle driver. The latter may include, for example the steering wheel 9 mentioned above, a brake pedal 15, a gas pedal 16 and, for example, a final control element 17 for the actuation of the level control device. Furthermore, the manual operator control device 13 may also have, for example, a shift lever for the transmission of the towing vehicle 4. The manual operator control device 13 is designed in such a way that the vehicle driver can input a driving request FW by means of the manual operator control device 13 into the control system 1 for manual operation of the vehicle combination 3. This driving request FW is processed in the manual operator control device 13 in such a way that the manual operator control device 13 generates outputs a standardized movement vector BV from the driving request FW on the input side.

The control system 1 is also equipped with a signal data transmission device 18, preferably in the form of a bus (particularly a CAN bus). The individual components of the control system 1 can communicate with one another via this data transmission device 18, for which purpose the corresponding components are connected to the data transmission device 18. Accordingly, the manual operator control device 13 feeds the generated movement vectors BV into the data transmission device 18.

The control system 1 further comprises a control device 19, which is fixedly installed on the towing vehicle 4 and includes, for example, a computer and a memory. The control device 19 is designed or programmed in such a way that it generates at its output control signals SS from the movement vectors BV on its input. These control signals are then fed to the individual components of the drive train 2, again via the data transmission device 18. The drive train 2 can then process the control signals SS, so that finally the input driving requests FW are implemented. The control device 19 consequently defines a coordination level of the control system 1.

According to the invention, the control system 1 is also equipped with a trailer coordination device 20, which is fixedly arranged on the towing vehicle 4 and interacts in a suitable way with the control device 19. The trailer coordination device 20 can be used to read in or input one or more trailer-specific actual values IW on the input side into the control system 1, and to pass on the trailer-specific actual values IW to the control device 19 via the data transmission device 18. According to the invention, during the processing of the movement vectors BV, the control device 19 generates the control signals SS based on the trailer-specific actual values IW. Specifically when maneuvering (particularly reversing), this can lead to considerable interventions during the determination of the control signals, since the kinematics of a multi-element vehicle (that is, a vehicle combination 3) are considerably more complex than those of a single-element vehicle. Taking account of trailer-specific actual values IW in the control signals SS allows operation of the vehicle to be carried out with increased safety.

For determination of trailer-specific actual values IW, the control system 1 may be equipped with an articulating angle sensor 21 and/or with a towbar angle sensor 22. The articulating angle sensor 21 determines an articulating angle α and generates an articulating angle signal correlated with it. The data transmission device 18 therefore allows the articulating angle α or the signal correlated with it to be passed to the trailer coordination device 20, which feeds the articulating angle α into the control system 1 as a trailer-specific actual value IW. In a corresponding manner, the towbar angle sensor 22 senses a towbar angle β and feeds it (or a towbar angle signal correlated with it) into the data transmission device 18, so that the towbar angle 18 reaches the trailer coordination device 20. The trailer coordination device 20 interprets the towbar angle β as a trailer-specific actual value IW and feeds it in a corresponding form or coding into the control system 1.

According to FIG. 4a, the trailer 5 in vehicle combination 3 comprises a semitrailer 5a. In this embodiment, the articulating angle β is formed between the towing vehicle 4 and the semitrailer 5a (that is, between a longitudinal axis 23 of the towing vehicle and a longitudinal axis 24 of the trailer, which intersect in a swivel axis 25, so that the trailer 5a can be swiveled in relation to the towing vehicle 4.

In the embodiment according to FIG. 4b, the trailer 5 (in another embodiment, designated by 5b) has a rigid towbar 26, which is rigidly connected to the trailer 5b. In an embodiment of this type, the trailer 5b is generally equipped with only a central axle or double axle. In this embodiment, the articulating angle α is again formed between the towing vehicle 4 and the trailer 5b (that is, between the longitudinal axis 23 of the towing vehicle and the longitudinal axis 24 of the trailer, which here coincides with the longitudinal axis of the rigid towbar), the swivel axis 25 in this embodiment running through the coupling point between the rigid towbar 26 and a trailer coupling 27 of the towing vehicle 4.

In the embodiment according to FIG. 4c, the trailer 5 is steered with the aid of a steering towbar 28. (This special embodiment of the trailer 5 is designated by the reference numeral 5c.) For this purpose, represented in a simplified form, the steering towbar 28 is coupled to a steerable axle 29 of the trailer 5c, which is toward the towing vehicle 4 and can be pivoted about a pivot axis 30 in relation to the trailer 5c. In this embodiment, the articulating angle a is formed between the towing vehicle 4 and the steering towbar 28 (that is, between the longitudinal axis 23 of the towing vehicle and a longitudinal axis 31 of the steering towbar), with the longitudinal axis of the towbar extending through the swivel axis 25 and through the pivot axis 30. The towbar angle β is thus formed between the towbar 28 and the trailer 5c (that is, between the longitudinal axis 31 of the steering towbar and the longitudinal axis 24 of the trailer).

According to FIG. 1, the control system according to the invention may be equipped with a trailer control device 32, which is fixed on the trailer and makes it possible to read trailer-specific actual values, such as for example articulating angle α and/or towbar angle β, into the control system 1 and pass them on to the trailer coordination device 20. The trailer control device 32 may perform further functions, for example activation of a trailer-side braking system 33. It may also activate a support actuating device 34, which makes automatic extension and retraction of supports (not represented here) possible for setting down the trailer 5. The support actuating device 34 may in this case be activated by the manual operator control device 13, it expediently being possible for corresponding control commands likewise to be incorporated in the movement vector BV.

The towbar angle sensor 22 fixed on the trailer is expediently coupled to the trailer control device 32. The articulating angle sensor 21 can be mounted on the towing vehicle side, in a way corresponding to the embodiment shown in FIG. 1, and then expediently connected to the trailer coordination device 20.

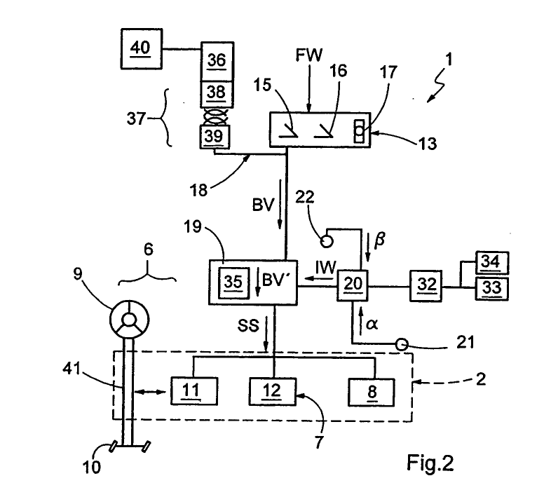

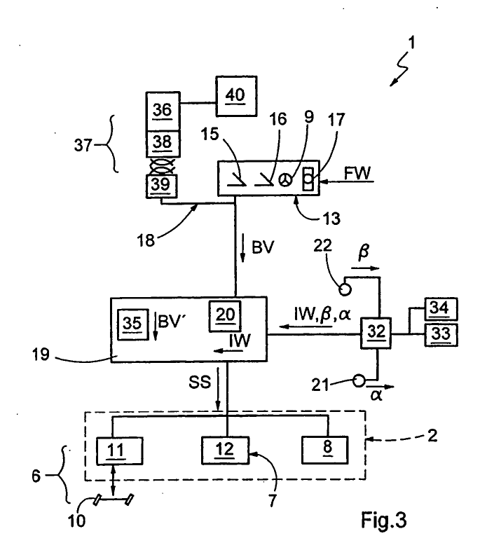

As result, it is also possible in principle to connect the towbar angle sensor 22 directly to the trailer coordination device 20 (compare FIG. 2) and/or to connect the articulating angle sensor (21) directly to the trailer control device 32 (compare FIG. 3).

According to FIG. 1, the control system 1 may also be equipped with a reverse assisting device 35, which is fixedly on the towing vehicle. The reverse assisting device 35 becomes active when the vehicle combination 3 is reversed, and then transforms the movement vector BV on the input side into a modified reversing movement vector BV′ on the output side. In this way, the control device 19 receives and processes the modified reversing movement vector BV′ and determines from it the control signals SS which are subsequently adapted to the respective reversing situation. When transforming the movement vector BV, the reverse assisting device 35 takes account of the trailer-specific actual values IW made available to the control system 1 via the trailer coordination device 20.

For example, the reverse assisting device 35 may be designed such that it is possible to input the driving requests when reversing the vehicle combination 3, in precisely the same way as if the vehicle were not a vehicle combination 3, but a single-element forward control vehicle. In this way, the vehicle driver or any other operator can maneuver the vehicle combination 3 within certain limits almost as easily as a conventional passenger car. For this purpose, the reverse assisting device 35 takes account of the complex kinematics of the vehicle combination 3 with the aid of the supplied trailer-specific actual values IW (such as articulating angle α and towbar angle β for example), and thereby simplifies maneuvering operation considerably.

According to FIG. 1, the control system 1 may also be equipped with at least one autonomous operator control device 36, which is independent of the vehicle combination. In a preferred embodiment shown here, the autonomous operator control device 36 communicates wirelessly with the other components of the control system 1. Provided for this purpose is a suitable transceiver arrangement 37, which includes a first transceiver unit 38 assigned to the autonomous operator control device 36 and a second transceiver unit 39 connected to the data transmission device 18. For example, the transceiver units 38, 39 communicate by means of radio and infrared signals.

The autonomous operator control device 36 may in principle comprise the same operating elements as the manual operator control device 13 fixed on the vehicle, but in a correspondingly adapted form. Accordingly, the autonomous operator control device 36 has, for example, operating elements (not shown in more detail) for braking, accelerating, steering and, in particular, gear-shifting and level-controlling the vehicle combination 3.

Like the manual operator control device 13, which is fixed on the vehicle, each autonomous operator control device 36, which is independent of the vehicle combination, can be used to input a driving request FW into the control system 1 for autonomous operation of the vehicle combination 3. The autonomous operator control device 36 then generates a standardized movement vector BV from the driving request FW. In manual operation of the vehicle combination 3 the control device 19 thus processes the movement vectors BV of the manual operator control device 13, while and in autonomous operation of the vehicle combination 3 it processes the movement vectors BV of the autonomous operator control device 36.

In a simple case, the autonomous operator control device 36 forms a portable remote control for the vehicle combination 3, with which the vehicle driver or other operator can maneuver the vehicle combination 3 without having to be in the cockpit 14. This may be advantageous for example when reversing to drive onto a loading ramp or the like.

Another embodiment of such an autonomous operator control device 36 may have a path computer 40, which calculates a path of movement defined by a sequence of movement vectors BV, based on actual values and setpoint values on the input side for an orientation and position of the towing vehicle 4 and the trailer 5. The movement vectors BV which define this path of movement can be converted into control signals SS by the control device 19 and processed by the drive train 2, so that the vehicle combination 3 is then automatically moved from its actual orientation and position into the desired setpoint orientation and position. For example, the setpoint orientation and position define an optimum relative orientation of the vehicle combination 3 with respect to a predetermined loading station.

The actual values for the orientation and position of the vehicle combination 3 may be determined for example with an orientation- and position-determining device (not shown) and made available to the path computer 40. For example, an orientation- and position-determining device of this type may be integrated in the vehicle combination 3 and comprise at least one readable compass and a satellite-aided navigation device. As an alternative to such an internal orientation- and position-determining device, an external device, which operates for example with image processing or on the sonar or radar principle, may also be provided. Such an external orientation- and position-determining device may for example monitor the site of an automated freight forwarding yard, operations yard or logistics center in which the vehicle combination 3 can be autonomously operated, and in which at least one predetermined setpoint orientation and setpoint position is provided for the trailer 5 or for the towing vehicle 4 (for example in the form of a parking space or a loading station). The autonomous operator control device 36 and the path computer 40 then preferably form component parts of this automated freight forwarding yard or operations yard or logistics center. In this way, the vehicle combination 3 can in principle be operated without a driver, autonomously and under remote control, on the site of the installation mentioned.

The control device 19 expediently detects whether the movement vectors BV on the input side originate from the manual operator control device 13 or from an autonomous operator control device 36. In autonomous operation of the vehicle combination 3, the control device 19 expediently limits its maximum speed to a reduced value, for example walking speed.

Furthermore, it is also possible in principle that the vehicle combination 3 be autonomously operated by means of the autonomous operator control device 36 (for example within a logistics center), while the vehicle driver is still in the cockpit 14. As a result, the vehicle driver could knowingly or unknowingly intervene in the autonomous operation of the control vehicle 3 by means of the manual operator control device 13. Expediently in autonomous operation of the vehicle combination 3 the control device 19 also allows movement vectors BV of the manual operator control device 13 and, in the event of a conflict of movement vectors BV of the manual operator control device 13 with movement vectors BV of the autonomous operator control device 36, it decides on the basis of predetermined criteria which movement vectors BV are actually fully or partly taken into account and converted into control signals SS. For example, the control device 19 may prioritize steering commands and acceleration commands of the autonomous operator control device 36, while it prioritizes braking commands of the manual operator control device 13. This means that, in autonomous operation of the vehicle combination 3, actuation of the steering wheel 9 and of the gas pedal 16 of the manual operator control device 13 remain ineffective, so that the vehicle driver can only intervene in the driving operation of the vehicle combination 3 with the brake pedal 15. Prioritization of conflicting movement vectors BV may in principle also based on some other safety philosophy. For example, in autonomous operation, movement vectors BV of the manual operator control device 13 may be completely ignored.

While in the embodiments of FIGS. 1 and 3 the steering system 6 is designed as a steer-by-wire system, FIG. 2 shows an embodiment in which the steering system 6 has a mechanical and/or hydraulic positive coupling between the steering wheel 9 and the steerable wheels 10 (specifically, in the form of a steering column 41). To realize the control system 1 according to the invention, this basically mechanical and/or hydraulic steering is also equipped with the electronically activatable steering actuator 11, which in this embodiment is drive-connected to the steering column 41. In this way, basically conventional vehicle steering by means of a steering wheel 9, steering column 41 and steerable wheels 10 can be actuated with the aid of the control signals SS by the steering actuator 11 driving the steering column 41 in a suitable way. In this embodiment, in the case of a towing vehicle 4 which has convention steering it is thus possible in principle to realize the control system 1 according to the invention by fitting a steering actuator 11 of this type. For example, in this way, conventional vehicles can be retrofitted with an activatable drive train 2 for operation in a logistics center of the type described above.

The embodiment shown in FIG. 2 also differs from that of FIG. 1 in that the reverse assisting device 35 is integrated in terms of hardware or implemented in terms of software, in the control device 19.

FIG. 3 shows a further variant, which differs from those of FIGS. 1 and 2 in that the trailer coordination device 20 is integrated in terms of hardware or implemented in terms of software in the control device 19. It is clear that, in a variant of the embodiment according to FIG. 3, the reversing assisting device 35 may also be arranged externally with respect to the control device 19, as in the embodiment according to FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-18. (canceled)

19. A control system for a vehicle combination comprising a towing vehicle and a trailer, with an electronically activatable drive train that includes at least a steering system, a braking system and a drive unit; wherein:
a manual operator control device which is fixed on the vehicle can be used by the vehicle driver to input a driving request for manual operation of the vehicle combination, and generates a standardized movement vector from the driving request;
a control device which is fixed on the towing vehicle, outputs control signals for activating the drive train, based on a movement vector on the input side and, for the transmission of the control signals, is coupled to the drive train, which processes the control signals to implement the driving request;
a trailer coordination device, which is fixed on the towing vehicle, reads in at least one trailer-specific actual value, which it passes on to the control device; and
the control device generates the control signals based on the at least one trailer-specific actual value.

20. The control system as claimed in claim 19, wherein:
an articulating angle sensor senses, as a trailer-specific actual value, a current actual articulating angle between the towing vehicle and a steering towbar of a trailer that can be steered by the steering towbar, a trailer formed as a semitrailer or a trailer rigidly connected to a rigid towbar, and generates an articulating angle signal correlated thereto; and
the articulating angle sensor is fixed on one of the towing vehicle and the trailer.

21. The control system as claimed in claim 20, wherein a towbar angle sensor, which is fixed on the trailer, senses as a trailer-specific actual value, a current actual towbar angle between the towbar and the trailer, and generates a towbar angle signal correlated with it.

22. The control system as claimed in claim 21, wherein for transmission of the articulating angle signal or the towbar angle signal, at least one of the articulating angle sensor and the towbar angle sensor is coupled to the trailer coordination device.

23. The control system as claimed in claim 22, wherein a trailer control device, which is fixed on the trailer, can be used to record a trailer-specific actual value, and passes on the actual value IW to the trailer coordination device.

24. The control system as claimed in claim 23, wherein for transmission of the articulating angle signal or the towbar angle signal, at least one of the articulating angle sensor and the towbar angle sensor is coupled to the trailer control device.

25. The control system as claimed in claim 24, wherein the trailer coordination device is implemented in the form of hardware or software, in the control device.

26. The control system as claimed in claims 25, wherein during reversing of the vehicle combination, a reverse assisting device, which is fixed on the towing vehicle, transforms an input movement vector into an output reversing movement vector, based on the at least one trailer-specific actual value, and makes it available to the control device.

27. The control system as claimed in claim 26, wherein, during reversing of the vehicle combination, the reverse assisting device makes it possible to input the driving requests in the same way as when reversing a single-element forward control vehicle.

28. The control system as claimed in claim 26, wherein the reverse assisting device is implemented in the control device, in the form of hardware or software.

29. The control system as claimed in claim 28, wherein at least one autonomous operator control device is provided independently of the vehicle combination, which device can be used to input a driving request for autonomous operation of the vehicle combination and generates a standardized movement vector from the driving request.

30. The control system as claimed in claim 29, wherein the steering system is designed as a steer-by-wire system.

31. The control system as claimed in claim 29, wherein:
the steering system has a longitudinal column for at least one of mechanical and hydraulic coupling of a manual steering device to steerable wheels of the towing vehicle;
the steering system also has an electronically activatable steering actuator, which is drive-connected to the steering column and can be activated by the control signals of the steering device, at least during autonomous operation of the vehicle combination.

32. The control system at least as claimed in claim 29, wherein at least one autonomous operator control device has a path computer, which, based on input actual values and setpoint values for the orientation and position of the towing vehicle and the trailer, calculates a path of movement which comprises a sequence of movement vectors that move the vehicle combination from the actual orientation and the actual position into the setpoint orientation and setpoint position when the movement vectors of the path of movement are processed.

33. The steering system as claimed in claim 32, wherein at least one of the autonomous operator control device and the path computer is a component part of an automated freight forwarding yard, operations yard, or logistics center for vehicles which can be driven autonomously.

34. The control system as claimed in claim 33, wherein the control device and the autonomous operator control device have wireless communication capability.

35. The control system as claimed in claim 34, wherein in autonomous operation, the control device reduces a maximum speed of the vehicle combination.

36. The control system as claimed in claims 35, wherein:
in autonomous operation, the control device allows entry of movement vectors of the manual operator control device; and, in the event of a conflict of movement vectors of the manual operator control device with movement vectors of the autonomous operator control device, the control device prioritizes steering commands and acceleration commands of the autonomous operator control device and prioritizes braking commands of the manual operator control device.
